(19) United States
(12) Patent Application Publication
(10) Pub. No.: US 2013/0260746 A1
(43) Pub. Date: Oct. 3, 2013

(54) RADIO BASE STATION, RADIO NETWORK CONTROLLER AND METHODS THEREIN

(71) Applicants: Torbjörn Wigren, Uppsala (SE); Zhang Zhang, Beijing (CN)

(72) Inventors: Torbjörn Wigren, Uppsala (SE); Zhang Zhang, Beijing (CN)

(73) Assignee: Telefonaktiebolaget L M Ericsson (publ), Stockholm (SE)

(21) Appl. No.: 13/992,348

(22) PCT Filed: Dec. 21, 2010
(86) PCT No.: PCT/SE10/51443

§ 371 Date: Jun. 7, 2013

(51) Int. Cl. H04W 24/08

(52) U.S. Cl. CPC H04W 24/08
USPC 455/423

(57) ABSTRACT

Embodiments herein relate to a method in a radio base station for estimating a noise floor in a cell of a radio communications network. The radio base station is comprised in the radio communications network and serves the cell in the radio communications network. The radio base station determines a time interval in which time interval the noise floor in the cell is to be estimated. The radio base station further reduces a first interference during the determined time interval in the cell and then measures a second interference in the cell at a time in the time interval in the cell. The radio base station then estimates the noise floor using the measured second interference.

### TECHNICAL FIELD

Embodiments herein relate to a radio base station, a radio network controller, and methods therein. In particular, embodiments relate to enabling noise floor estimation in a cell of a radio communications network.

### BACKGROUND

In today's radio communications networks a number of different technologies are used, such as Long Term Evolution (LTE), LTE-Advanced, 3rd Generation Partnership Project (3GPP) Wideband Code Division Multiple Access (WCDMA) system, Time Division Synchronous Code Division Multiple Access (TD-SCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few. A radio communications network comprises radio base stations providing radio coverage over at least one respective geographical area forming a cell. User equipments are served in the cells by the respective radio base station and are communicating with respective radio base station. The user equipments transmit data over an air interface to the radio base stations in uplink (UL) transmissions and the radio base stations transmit data to the user equipments in downlink (DL) transmissions. In a cell a load of the air interface is defined by a traffic load in the cell, a traffic load in neighboring cells and also a thermal load generated by electronics, antennas and other components in the radio communications network.

A momentary load of an uplink of the air interface in for example WCDMA is taken into account and is important when scheduling transmissions in the radio base station (RBS) for enhanced uplink (EUL) user equipments, also known as High-Speed Uplink Packet Access (HSUPA) user equipments. EUL user equipments are user equipments with an improved performance of uplink dedicated transport channels, i.e. to increase capacity and throughput and reduce delay.

The momentary load of the air interface is also important for algorithms for admission and congestion control, in a Radio Network Controller (RNC), that also control a load created by legacy user equipments such as Release 99 user equipment, also referred to as WCDMA user equipments. The algorithms for admission and congestions control monitor the load and allow admission of user equipments to the cells as well as data rate within the cells based on the monitoring.

There are several reasons for that the momentary load is taken into account and important when scheduling and/or for algorithms for admission and congestion control. First a fast inner power control loop coupling between user equipments may create instability if too much load is allowed in an uplink (UL), also known as the party effect. The fast inner power control loop means that the user equipment adjusts its transmission power in accordance with one or more Transmit Power Control (TPC) commands received from the radio base station in order to keep an uplink Signal-to-Interference Ratio (SIR) at a given SIR target in the radio base station. The user equipment increases/decreases the transmission power in power increments based on the TPC command received.

Such a power rush originates e.g. when a new high power user equipment is entering the uplink causing interference. Since the fast inner power control loop strives to maintain uplink SIR at the given SIR target, the consequence is that the other user equipments of the cell increase their powers, which in turn increases the interference and leads to additional power increments. At a certain point this process goes unstable with unlimited power increments of all user equipments in the uplink of the cell.

Furthermore, increased interference levels reduce the coverage, simply because a user equipment needs to transmit with a higher power to overcome an increased interference level. At the cell boundary, the user equipment power is hence saturated, meaning that the user equipment must move towards the radio base station to be detected, hence the cell size is reduced.

Additionally the scheduling of enhanced uplink user equipments in the radio base station does not account for legacy traffic from user equipments that do not support EUL. Even modern user equipments, e.g. some smartphones, may lack support for EUL. In order to keep the momentary load under control, legacy traffic must hence be monitored elsewhere. In for example WCDMA this control functionality is performed in the radio network controller, by algorithms for admission and congestion control implemented therein. Since the consequences, instability and loss of coverage, are the same as for EUL user equipments when the air interface becomes over-utilized, it follows that also the admission and congestion control algorithms need to have access to a measure of the momentary load.

It is also crucial that the measure of the momentary load is accurate. This follows since the momentary load, which is expressed as a noise rise explained below, is usually limited to be below 10 dB. It also follows that any load estimation errors will require margins that reduce the limit of 10 dB to lower values, a fact that will reduce the cell capacity. Hence, all quantities that are used to form the momentary load need to be estimated very accurately, e.g. at 0.1-0.2 dB level, not to limit uplink performance of the radio communications network.

The momentary load is expressed as a so called noise rise, i.e. a total amount of relevant interference power, divided by the noise floor of the uplink receiver chain in for example WCDMA, TD-SCDMA or similar systems. The noise floor is a measure of the signal, which measure is the sum of all the electronics noise sources in the UL. Since variation in electronics components result in noise floor variations of 1-3 dB between different radio base stations, and since factory calibration is too costly and since such calibration is anyway uncertain due to highly varying installation procedures and corresponding cabling losses, an estimation of the noise floor is so accurate and therefore the estimation of the momentary load is not achieved.

Estimation of the noise floor in the uplink is a difficult problem. The noise floor is today estimated as a minimum value taken over time of a power quantity that at least comprises the noise floor plus the neighbor cell interference. It is stressed that the noise floor estimation algorithms described in prior art are today integral parts of the enhanced uplink (EUL) functionality of the radio base stations. Thus, there is a problem that it is very hard to observe the noise floor, i.e. the estimated minimum value will be above the accurate noise floor. This problem is increasing rapidly today and the load estimation of the EUL face the risk of a collapse, together with EUL as such.

### SUMMARY

An object of embodiments herein is to enable an accurate and efficient way to estimate noise floor in a cell.

According to an aspect of embodiments herein the object is achieved by a method in a radio base station for estimating a noise floor in a cell of a radio communications network. The radio base station is comprised in the radio communications network and serves the cell in the radio communications network. The radio base station determines a time interval in which time interval the noise floor in the cell is to be estimated. The radio base station reduces a first interference during the determined time interval in the cell and measures a second interference in the cell at a time in the time interval when the first interference is reduced. The radio base station then estimates the noise floor using the measured second interference.

According to another aspect of embodiments herein the object is achieved by a radio base station for estimating a noise floor in a cell of a radio communications network. The radio base station is configured to serve the cell. The radio base station comprises a determining circuit configured to determine a time interval in which time interval the noise floor in the cell is to be estimated. The radio base station further comprises a reducing circuit configured to reduce a first interference during the determined time interval in the cell. The radio base station also comprises a measuring circuit configured to measure a second interference in the cell at a time in the time interval when the first interference is reduced. Furthermore, the radio base station comprises an estimating circuit configured to estimate the noise floor using the measured second interference.

Thus, the radio base station reduces the interference from its own traffic activity when estimating the noise floor resulting in a more accurate estimation.

According to another aspect of embodiments herein the object is achieved by a method in a radio network controller for enabling estimation of a noise floor in a cell in a radio communications network. The radio network controller is comprised in the radio communications network and controls a radio base station serving the cell. The radio network controller determines a time interval in which time interval the noise floor in the cell is to be estimated. The radio network controller then signals information to the radio base station, a different radio base station, and/or a different radio network controller. The information is based on the time interval.

According to another aspect of embodiments herein the object is achieved by a radio network controller for enabling estimation of a noise floor in a cell in the radio communications network. The radio network controller is configured to control a radio base station serving the cell. The radio network controller comprises a determining circuit configured to determine a time interval in which time interval the noise floor in the cell is to be estimated. The radio network controller also comprises a transmitter configured to signal information to the radio base station, a different radio base station, and/or a different radio network controller. The information is based on the time interval.

Thus, this information is used to reduce cell interference when estimating noise floor. The consequence is that means are provided that actively reduce the interference in the own cell but also in some embodiments the neighbor cell interference, so that a coordinated interference measurement for noise floor estimation will result in values close to the actual noise floor.

### BRIEF DESCRIPTION OF THE DRAWINGS

Embodiments will now be described in more detail in relation to the enclosed drawings, in which:

FIG. 1 is a block diagram depicting a radio communications network,

FIG. 2 is a schematic flow chart of a radio base station in a radio communications network,

FIG. 3 is a schematic combined signaling and flowchart in a radio communications network,

FIG. 4 is a schematic combined signaling and flowchart in a radio communications network,

FIG. 5 is a schematic combined signaling and flowchart in a radio communications network,

FIG. 6 is a schematic flowchart depicting a method in a radio base station,

FIG. 7 is a block diagram depicting a radio base station,

FIG. 8 is a schematic flowchart depicting a method in a radio network controller, and

FIG. 9 is a block diagram depicting a radio network controller.

### DETAILED DESCRIPTION

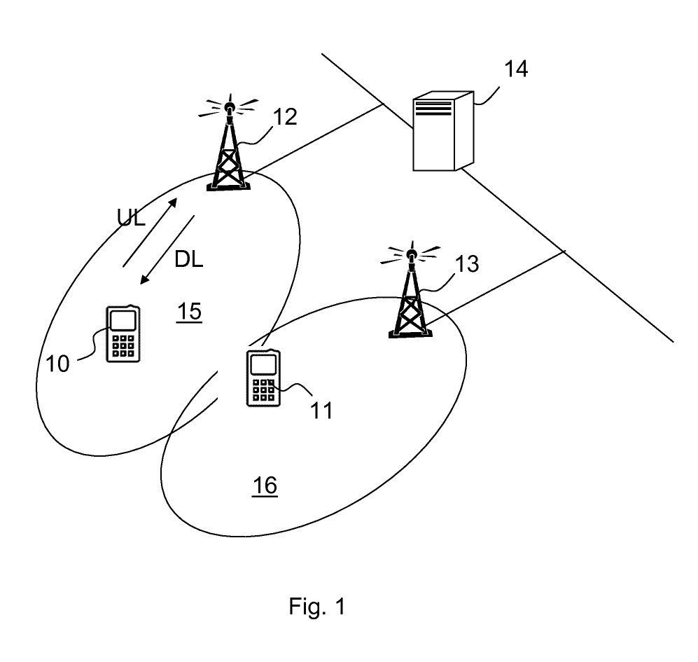

FIG. 1 is a block diagram of a radio communications network such as Long Term Evolution (LTE), LTE-Advanced, 3rd Generation Partnership Project (3GPP) Wideband Code Division Multiple Access (WCDMA) system, Time Division Synchronous Code Division Multiple Access (TD-SCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few.

A first user equipment 10 and a second user equipment 11 is comprised in the radio communications network. The first user equipment 10 is served in a first cell 15 controlled by a first radio base station 12. The second user equipment 11 is served by a second cell 16 controlled by a second radio base station 13. The radio base stations 12,13 provide radio coverage within a geographical area forming respective cell. The first user equipment 10 in the first cell 15 is communicating with the first radio base station 12 in an uplink (UL) transmission when data is transmitted to the first radio base station 12 and in a downlink (DL) transmission when data is sent to the first user equipment 10 from the first radio base station 12. A radio network controller 14 is also comprised in the radio communications network and controls the radio base stations 12,13. The first and second user equipment 10,11 may e.g. be represented by an enhanced uplink (EUL) user equipment, a wireless communication terminal, a mobile cellular phone, a Personal Digital Assistant (PDA), a legacy user equipment, a wireless platform, a laptop, a computer or any other kind of device capable to communicate wirelessly with the radio base stations 12,13.

The respective radio base station 12,13 may also be referred to as e.g. a NodeB, an evolved Node B (eNB, eNode B), a base transceiver station, Access Point Base Station, base station router, or any other network unit capable to communicate with a user equipment 10,11 within the cells 15,16 served by the respective radio base station 12,13, depending e.g. of the radio access technology and terminology used.

The first user equipment 10 may cause interference towards the first cell 15 as well as the second cell 16. Similarly, the second user equipment 11 may cause interference towards its own second cell 16 as well as the first cell 15. In order to perform an accurate scheduling and admission process in the radio communications network, an accurate estimated momentary load of the uplink is crucial for scheduling in the radio base station 12 and admission and control algorithms in the radio network controller 14.

To identify difficulties how to calculate an accurate momentary load the following equations will be discussed. The momentary load at an antenna connector at the radio base station of the uplink may be given by the noise rise, also referred to as Rise over Thermal, RoT(t), defined by

$$RoT ( t ) = \frac{RTWP ( t )}{N ( t )} , \\ \text{?} \text{indicates text missing or illegible when filed} \qquad ( E \text{?}$$

where
N(t) is a noise floor as measured at the antenna connector, and
RTWP(t) is a total wideband power also measured at the antenna connector, defined as:

$$RTWP ( t ) = {\sum }_{k = 1}^{K} {P}_{k} ( t ) + {I}^{N} ( t ) + N ( t ) , \\ \text{?} \text{indicates text missing or illegible when filed} \qquad ( E \text{?}$$

where
I^{N}(t) denotes a power as received from neighbor cells N of the WCDMA system at time instance t,
Pₖ(t) denotes the uplink power of user k, k ∈ 1-K

As will be seen below, the major difficulty of any RoT(t) estimation algorithm is to separate the thermal noise power, also referred to as the noise floor N(t), from the interference from neighbor cells.

The signal reference points are, by definition, at the antenna connector of the radio base station. However, the measurements are obtained after an analogue signal conditioning chain in a digital receiver of the radio base station 12. The analogue signal conditioning chain does introduce a scale factor error of about 1-3 dB denoted as γ(t) that is difficult to compensate for. Fortunately, all powers of (EQ2) are equally affected by the scale factor error so when (EQ1) is calculated, the scale factor error is cancelled as

$$\begin{matrix} {RoT}^{DigitalReceiver} ( t ) = \frac{{RTWP}^{DigitalReceiver} ( t )}{{N}^{DigitalReceiver} ( t )} = \\ = \frac{γ ( t ) {RTWP}^{Antenna} ( t )}{γ ( t ) {N}^{Antenna} ( t )} \\ = {RoT}^{Antenna} ( t )\end{matrix} \\ \text{?} \text{indicates text missing or illegible when filed} \qquad ( E \text{?}$$

In order to understand a fundamental problem of neighbor cell interference when performing load estimation, note that

I^{N}(t)+N(t)=E[I^{N}(t)]+E[N(t)]+ΔI^{N}(t)+ΔN(t), (EQ

where E[ ] denotes mathematical expectation and where Δ denotes the variation around the mean. Since there are no measurements available in the radio base station that are related to the neighbor cell interference, a linear filtering operation may at best estimate the sum E[I^{N}(t)]+E[N(t)]. This estimate cannot be used to deduce the value of expectation thermal noise, E[N(t)]. The situation is the same as when the sum of two numbers is available. Then there is no way to figure out the values of the individual numbers and a noise floor, also known as noise power floor load, is not mathematically observable.

A simulation for twenty five EUL user equipments revealed that the noise rise never fell below 3 dB. In case this situation persists around the clock, the noise floor will be overestimated with 3 dB as well, leading in turn to RoT underestimation, over-scheduling and cell stability impairment. Unfortunately, an always connected scenario predicts that smart phones and machine devices will be connected on the day as well as the night, keeping background signaling up at levels that makes it impossible to see the noise floor even during the night.

As described above, an accurate estimate of the momentary load of the uplink of the air interface may be important for

i) the accurate scheduling of enhanced uplink (EUL) user equipments and

ii) the accurate admission of legacy user equipments.

The consequence of any inaccuracy in this load estimation of the momentary load, is a need for corresponding margins and/or reduced thresholds for i) and ii), facts that immediately reduce the throughput of the uplink.

It is today hard to observe the noise floor. This is due to the “always connected” ambition of the cellular business, in connection with the strive to have a vast number of user equipments, e.g. smart phones and machines, simultaneously using the uplink. The problems defined above increase since always connected devices will transmit with low intensity. The vast amount of such user equipments may reduce a variation of the uplink load a lot, referring to the law of large numbers. This makes the interference level to appear as slightly varying around a mean value that varies slowly. Then the only way forward for load and noise floor estimation is to try and capture and exploit daily or even weekly load variations. Unfortunately, the always connected scenarios predict that smart phones and machine devices will be connected on the day as well as the night, keeping background signaling up at levels that makes it impossible to see the noise floor even during the night.

Embodiments provided herein actively reduce the interference, own interference and the neighbor cell interference, so that a coordinated interference measurement for noise floor estimation will result in values close to the noise floor. In order to be able to for example estimate the momentary load of the uplink as accurate as possible, embodiments herein disclose ways to estimate noise floor in an accurate and efficient manner.

Embodiments herein intentionally reduce the interference in the first cell 15 by reducing the uplink interference controlled by the first radio base station 12 of the first cell 15. This may be performed by a reduction of scheduled user grants at a certain time instance or time interval, said time interval may be computable according to a rule. The time interval relates to a time base, e.g. a Coordinated Universal Time (UTC) time, that is available to all radio base stations 12,13 of the radio communications network. UTC is also known as Greenwich Mean Time (GMT). Additionally, the UL interference may be reduced by a coordinated reduction of UL transmit rate/power of user equipments, controlled by additional signaling in the first cell 15, e.g. by using broadcast. The reduction of interference may occur at a time interval being computable according to a rule. The time interval may relate to a time base, e.g. UTC time, that is available to all radio base stations 12,13 of the radio communications network.

Additionally or alternatively the interference in the first cell 15 may be reduced by simultaneously reducing the UL interference generated by the second cell 16 or a set of neighbor cells by a reduction of scheduled user grants of said second cell 16 at a certain time instance or time interval. The time interval may be computable according to a rule and relates to a time base, e.g. UTC time, that is available to all radio base stations 12,13 of the radio communications network. This interference from the neighbor cells, e.g. second cell 16, may also be reduced by a coordinated reduction of user equipment UL transmit rate/power, controlled by additional signaling in the second cell 16, e.g. using broadcast. The reduction occurs at a time interval that may be computable according to a rule. The time interval may be related to a time base, e.g. UTC time, that is available to all radio base stations 12,13 of the radio communications network.

The interference in the first cell 15 may be reduced by simultaneously reduce the uplink interference generated by the second cell 16 or a set of neighbor cells in response to a signaling message chain originating from the first radio base station 12 of the first cell 15, and terminating in the second radio base stations 13 of said second cell 16. The interference reduction in said second cell 16 may be achieved by a reduction of scheduled user grants at certain signaled time interval from the first radio base station 12 of the first cell 15. The reduction of interference may also be achieved by a coordinated reduction of user equipment UL transmit rate/power, controlled by additional signaling in said second cell 16, e.g. using broadcast. The reduction of interference occurs at the certain signaled time interval from the first radio base station 12 of said first cell 15.

Thus, embodiments herein disclose ways of the first radio base station 12 coordinating a noise floor estimation of said first cell 15, to measure uplink interference at least at said time interval with intentionally reduced own cell interference and neighbor cell interference.

An alternative embodiment to achieve similar affects is to utilize the admission control function of the Radio Network Controller (RNC) 14 in order to starve the own serving cell, the first cell 15, and one or more neighbor cells, the second cell 16, in a coordinated way. Starve herein means to reduce the connected user equipments in the cells. The radio network controller 14 may reduce the UL interference of the first cell 15 by a reduction of the admission control threshold of said first cell 15 controlled by said radio network controllers 14 at a certain time interval, which time interval may be of longer duration than the above time interval, e.g. a time interval of several minutes. The time interval may be computable according to a rule, and relate to a time base, e.g. UTC time, that is available to all radio network controllers 14 of the radio communications network. Hence, the reduction may be maintained for a sufficiently long time to empty the first cell 15 of user equipments with a high likelihood, thereby achieving said reduction of interference. The radio network controller 14 may also reduce the interference of the second cell 16 by a reduction of the admission control thresholds of the second cell 16 controlled by said radio network controller 14 at the certain time interval. The time interval may be computable according to a rule, and relate to said time interval to a time base, e.g. UTC time, that is available to all radio network controllers 14 of the radio communications network. The reduction may be maintained for a sufficiently long time to empty the second cell 16 of user equipments with a high likelihood, thereby achieving said reduction of interference.

Thus, embodiments herein disclose ways of a radio network controller 14 coordinating a noise floor estimation of the first cell 15, to measure uplink interference at least at said time interval with intentionally reduced own cell interference and neighbor cell interference.

A sliding window algorithm may be used to estimate the RoT(t), as given by

$$RoT ( t ) = \frac{RTWP ( t )}{N ( t )} .$$

Since it is not possible in prior art to obtain exact estimates of the noise floor due to the neighbor cell interference, an estimator may therefore apply an approximation, by consideration of a soft minimum as computed over a relative long window in time. It should be understood that this estimation relies on the fact that the noise floor is constant over very long periods of time, disregarding the small temperature drift.

The sliding window algorithm of the above section requires a large amount of storage memory in case a large number of instances of the sliding window algorithm are needed, as may be the case when interference cancellation is introduced in the uplink.

To reduce the memory consumption a recursive algorithm may be used in accordance with the one shown in PCT/SE2006/050347. The recursive algorithm may also provide a soft probabilistic minimum estimation step that approximates the noise floor. The recursive algorithm is derived from the sliding window algorithm, using the fact that certain key quantities of the sliding window algorithm may be updated recursively, thereby condensing measurement information when it arrives in states that are related to the probability density function of the thermal noise floor, conditioned on all said previous measurements. This makes the need for a sliding window where such quantities are stored for all time instances of the sliding window, redundant. The use of this algorithm reduces the memory requirements of the sliding window scheme discussed above.

The embodiments herein are applicable both to the sliding window estimation algorithm and the recursive algorithm RoT(t).

Embodiments described herein may provide a coordinated interference reduction for multiple cells 15,16, in combination with a coordinated measurement of the total interference level, for noise floor processing. For example, the own interference may be reduced by power down the first user equipment 10 or redirect the first user equipment to a different carrier, and the neighbor cell interference may be reduced by power down the second user equipment 11 or redirect the second user equipment 11 to a different carrier.

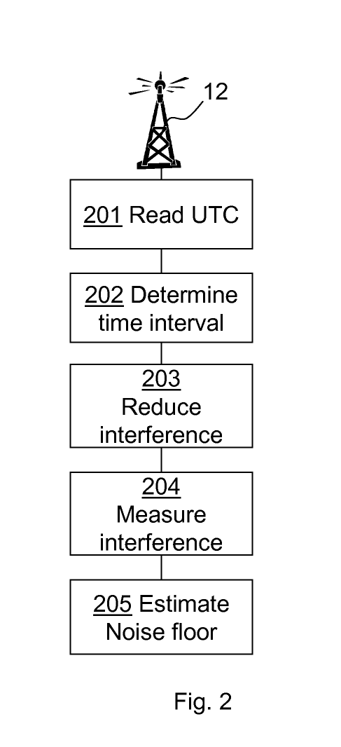

FIG. 2 shows a flow chart depicting a method in a radio communications network. The method may only affect interference caused by EUL and WCDMA traffic is not controlled. The first radio base station 12 estimates a noise floor in the first cell 15 of the radio communications network. The first radio base station 12 is comprised in the radio communications network and serves the first cell 15 in the radio communications network.

Step 201. The first radio base station 12 may synchronize to the network by reading a UTC time.

Step 202. The first radio base station 12 determines a time interval in which time interval the noise floor in the first cell 15 is to be estimated. This may be preconfigured or determined based on traffic measurements, received from a second radio base station 13 or the radio network controller 14, or similarly.

Step 203. The first radio base station 12 reduces a first interference in the uplink during the determined time interval in the first cell 15. The first radio base station 12 may reduce the interference by reducing traffic, or reducing transmission power of user equipments in the first cell 15. Thus, a more accurate noise floor estimation may be performed by reducing other interferences than the noise floor.

Step 204. The first radio base station 12 measures a second interference in the first cell 15 in an uplink transmission at a time in the time interval. The second interference may be measured for use in a noise floor estimator of the first radio base station 12.

Step 205. The first radio base station 12 estimates the noise floor using the measured second interference.

The noise floor may then be used when scheduling traffic at the radio base station 12, performing admission control in the first cell 15 of the radio network controller 14 or similar.

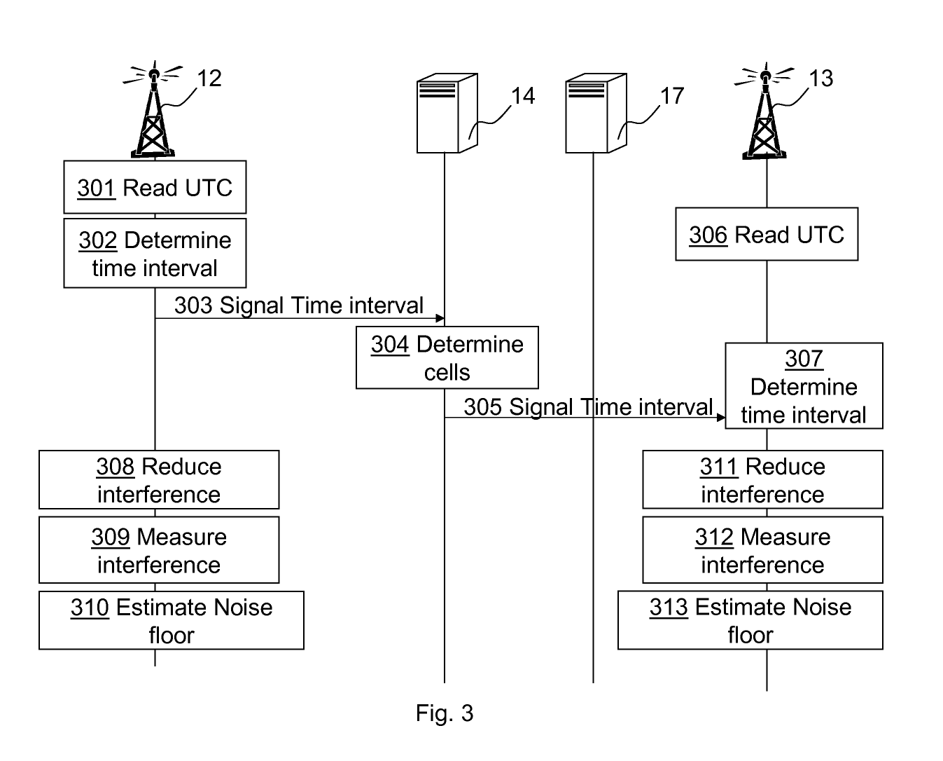

FIG. 3 is a combined flowchart and signaling scheme depicting a method in the radio communications network. In the illustrated example the first radio base station 12 is referred to as the first radio base station 12 and another radio base station is introduced, the second radio base station 13. Note that the illustrated embodiment affects EUL traffic and WCDMA traffic cannot be affected.

Step 301. The UTC time may be read in the first radio base station 12 of the own first cell 15. It should be understood that other time bases are possible.

Step 302. The first radio base station 12 determines a time interval in which time interval the noise floor in the first cell 15 is to be estimated. This may be preconfigured or determined based on traffic measurements, received from a different radio base station or a radio network controller, or similarly. A computational rule may be used to determine that it's time for an interference measurement to support the noise floor estimation. An interference controller of the first radio base station 12 of the first cell 15 may be handling this.

Step 303. The first radio base station 12 transmits the time interval to the radio network controller 14. For example, the interference controller of the first cell 15 initiates signaling a message over the Iub interface to the radio network controller 14 or a proprietary interface. The message may comprise information of the time interval during which interference reduction in the uplink performed by a scheduler in the radio base station 12 is to take place, in a neighbor cell, such as the second cell 16, of the first cell 15. Iub interface is the communication interface between the radio base station 12 and the radio network controller 14.

Step 304. The radio network controller 14 may determine the neighbor cells of the first cell 15 to which the radio network controller may signal the message to, e.g cells of the second radio base station 13. This may be determined from a stored neighbor cell list of cell identities and cell relations. Neighbor cells may be controlled by the first radio base station 12, the second radio base station 13, or a radio base station controlled by a different radio network controller.

Step 305. The radio network controller 14 may then signal an indication of the time interval to the second radio base station 13 controlling the second cell 16. It should here be noted that the radio network controller 14 may transmit the time interval to a number radio base stations controlling a number of cells. Thus, the time interval may be transmitted via a radio network node, such as another radio network controller 17. The indication may be transmitted over Iur or Iub. The Iur interface is the communication interface between radio network controllers 14,17.

Step 306. The second radio base station 13 may read a network clock such as the UTC time to get synchronized to the radio communications network in order to have a corresponding time interval in all the radio communications network.

Step 307. The second radio base station 13 determines the time interval in which time interval the noise floor in the first cell 15 is to be estimated, for example, from the received indication of the time interval from the radio network controller 14.

Step 308. The first radio base station 12 reduces the first interference in the uplink during the determined time interval in the first cell 15. Thus, a more accurate noise floor estimation may be performed by reducing other interferences. The first radio base station 12 may reduce the interference in the uplink by reducing traffic, or reducing transmission power of user equipments in the first cell 15. It should also be noted that the interference in the uplink towards other cells are also reduced.

Step 309. The first radio base station 12 then measures the second interference in the uplink in the first cell 15 at a time within the time interval, when the first interference is reduced.

Step 310. The first radio base station 12 estimates the noise floor in the first cell 15 using the measured second interference.

Step 311. The second radio base station 13 also reduces the first interference in the uplink in the second cell 16 during the time interval. Thereby the interference towards the first cell 15 of the first radio base station 12 is also reduced. The second radio base station 13 may reduce the first interference by reducing traffic, or reducing transmission power within the second cell 16.

Step 312. The second radio base station 13 measures the second interference in the second cell 16 a time within the time interval.

Step 313. The second radio base station 13 may then estimate the noise floor in the second cell 16 using the measured second interference.

Thus, during the indicated time interval, the interference within the first cell 15 and the interference from second cell 16 are reduced simultaneously, resulting in a more accurate estimate of the noise floor in the first cell 15. Thus, herein a coordinated reduced interference from neighbouring cells may be achieved as traffic activity or traffic power in the neighbor cells are reduced over the same time interval.

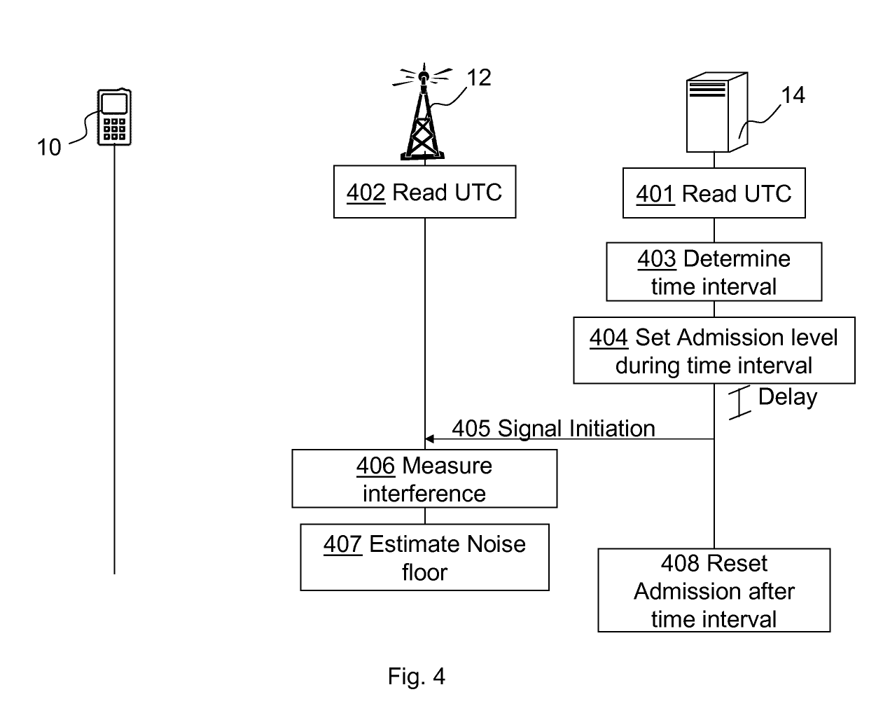

FIG. 4 is a combined flowchart signaling scheme depicting a different embodiment that has the advantage that both WCDMA and EUL traffic is handled to “starve” cells of user equipments by temporarily reducing the admission control thresholds of a set of cells in a coordinated way. This embodiment resides in the Radio Network Controller (RNC) node 14 and does not require any signaling.

Step 401. The radio network controller 14 may read a UTC time. The UTC time may be read by all Radio network controllers of the radio communications network.

Step 402. Also, the first radio base station 12 synchronizes to the network by reading the UTC time.

Step 403. The radio network controller 14 determines a time interval. The noise floor in the first cell 15 is to be estimated within the time interval. A computational rule may be used to determine that it's time for an interference measurement to support the noise floor estimation. The rule may be preconfigured or updated based on traffic statistics. It should also be noted that the radio network controller 14 may determine the time interval from an indication received from a radio base station or the different radio network controller 17.

Step 404. The radio network controller 14 sets an admission control threshold of the first cell 15. The admission control threshold is lowered from a current level. The admission control threshold may be set so that no new user equipments are admitted to the first cell 15, these user equipment may instead be directed e.g. to another carrier.

Step 405. After a delay in time and before the end of the time interval with reduced admission control threshold, the radio network controller 14 may transmit an initiation command to the first radio base station 12. The initiation command orders the radio base station to start measuring interference in the first cell 15. This initiation command may indicate a time start or just state that the interference measuring should start immediately. Thus, the initiation command may merely indicate ‘start measuring interference’. The delay is used to enable the first radio base station 12 to empty the user equipments connected within the first cell 15.

Step 406. The first radio base station 12 of the first cell 15 measures the second interference based on the received initiation command is received for use in the noise floor estimator of the first radio base station 12

Step 407. The first radio base station 12 then estimates the noise floor using the second interference.

Step 408. The radio network controller 14 may then raise the admission control threshold to the normal level after the time interval has expired.

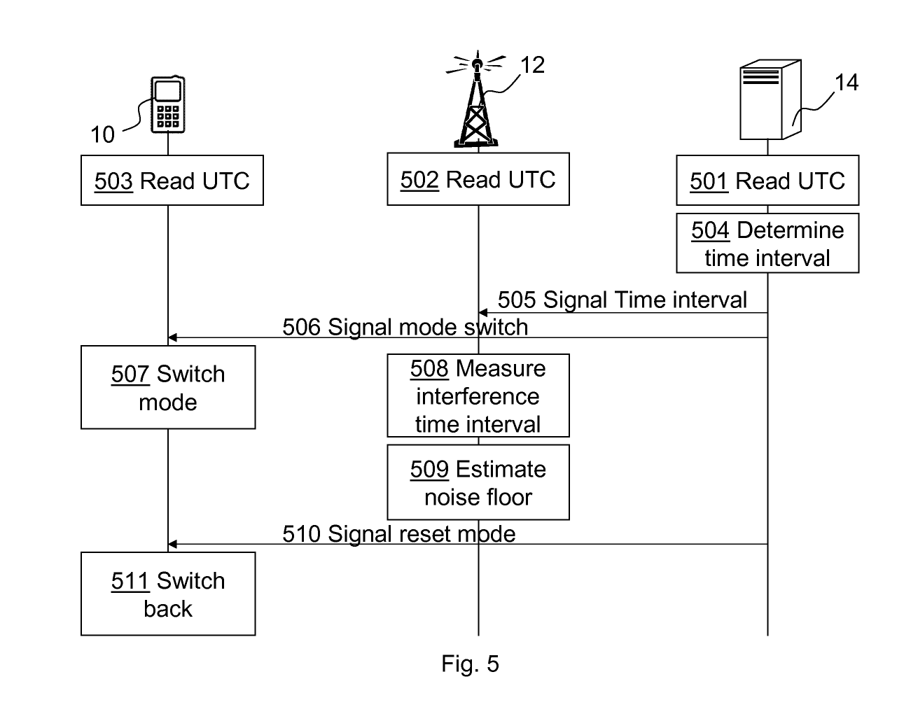

FIG. 5 is a combined schematic flowchart and signaling scheme depicting a method in the radio communications network. The method is e.g. applicable if EUL is not available or for control of WCDMA traffic. A distinct advantage is that both WCDMA traffic and EUL traffic is affected.

Step 501. The radio network controller 14 may synchronize to the radio communications network by reading the UTC time.

Step 502. The first radio base station 12 may also synchronize to the radio communications network by reading the UTC time.

Step 503. The first user equipment 10 may also synchronize to the radio communications network by reading the UTC time.

Step 504. The radio network controller 14 determines a time interval in which time interval the noise floor in the first cell 15 is to be estimated. For example, a computational rule may be used to determine that it's time for an interference measurement to support the noise floor estimation, in a cluster of cells. An interference controller of the radio network controller 14 of the first cell 15 may be handling this.

Step 505. The interference controller of the radio network controller 14 may initiate signaling a message over the Iub interface to the first radio base station 12 or over Iur interface to other radio network controllers. The message may comprise information of the time interval during which a dedicated user equipment power down is to take place, in a cluster of cells. The information may be passed on to a noise floor estimation unit in the first radio base station 12.

Step 506. The interference controller of the radio network controller 14 may initiate signaling a message over a Radio Resource Control (RRC) interface to all user equipments. The message may comprise information of the time interval during which a dedicated user equipment power down is to take place, in the cluster of cells. It should be noted that an additional feature is to augment a broadcast service to transmit this information to the user equipments.

Furthermore, the radio network controller 14 may order a power down or a stop of traffic activity in the first cell 15. In the illustrated embodiment the radio network controller 14 signals a mode switch to the first user equipment 10.

Step 507. The first user equipment 10 receives the message indicating the mode switch and switches to a different mode. Thereby the first user equipment 10 uses a low transmission power or just being in an idle mode. Thus, user equipments within a cluster of cells may perform a dedicated power down.

Step 508. The first radio base station 12 measures the second interference indicated at a time in the time interval from the radio network controller 14. During the indicated time interval, the second, or total, interference in the uplink is measured for use for noise floor estimation of the first radio base station 12 and other radio base stations of the cluster of cells.

Step 509. The first radio base station 12 estimates the noise floor using the measured second interference.

Step 510. The radio network controller 14 may further signal a message to the first user equipment 10 after the time interval has expired. The message indicates that the operation mode of the first user equipment 10 should be switched back.

Step 511. The first user equipment 10 receives the message from the radio network controller 14 and switches back to the original power mode.

To reduce WCDMA traffic, a straightforward way is to switch down user equipments to lower transmission rates, or even to Cell Forward Access Channel (Cell-FACH) state or UTRAN Registration Area (URA) state. Switch down may be performed in many different ways. It may however be noted that the interference controller in this case is located in the radio network controller 14 and that the normal interfaces used for Radio Access Bearer (RAB) switch are invoked, e.g. Radio Resource Control (RRC) and Radio Network Subsystem Application Part (RNSAP). RRC is the protocol used between the first radio base station 12 and the radio network controller 14 carried over Iub interface. RNSAP is the protocol used between radio network controllers carried over the Iur interface.

An advantage of embodiments herein include the fact that the noise floor can be estimated, even with “many always connected” users. This enables a future proof use of load estimation and thereby EUL in future WCDMA RBS products.

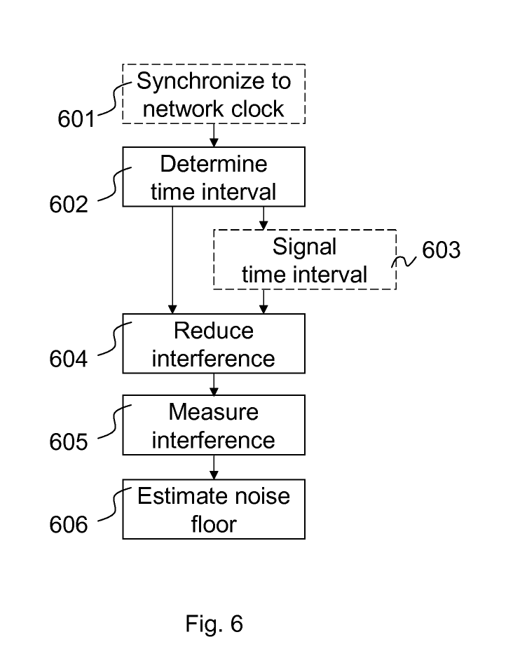

FIG. 6 is a flow chart of a method in a radio base station, referred to as the first radio base station 12 above, for estimating a noise floor in a cell 15, referred to as the first cell 15, of a radio communications network. The radio base station 12 is comprised in the radio communications network and serves the cell 15 in the radio communications network. The steps do not have to be taken in the order stated below, but may be taken in any suitable order.

Step 601. In some embodiments as indicated by the dashed line, the radio base station 12 may synchronize an internal clock to a radio network clock, such as a UTC time or similar. Thus, a time interval in the radio base station 12 is similar within all synchronized radio network nodes in the radio communications network.

Step 602. The radio base station 12 determines a time interval in which time interval the noise floor in the cell 15 is to be estimated. This time interval may be preconfigured or determined based on traffic measurements, received from radio network node, such as a different radio base station 13 or a radio network controller 14, or similarly. The length of the time interval may be pre-configured and the time to initiate the time interval may be determined from traffic analyses or pre-configured at the radio network controller

Step 603. In some embodiments as indicated by the dashed line, the radio base station 12 signals information to a radio network controller 14, which information comprises the time interval for reducing the first interference. Thereby, other cells may be ordered to reduce their interference within their cells. This will result in that interference from neighboring cells towards the cell 15 is reduced simultaneously and the noise floor may be estimated even more accurate.

Step 604. The radio base station 12 reduces a first interference during the determined time interval in the cell 15. The first interference may be reduced by reducing traffic or transmission power of user equipments in the cell 15, thus the interference is reduced in the uplink of communication.

Step 605. The radio base station 12 measures a second interference in the cell 15 at a time in the time interval when the first interference is reduced. The measuring of the second interference may be performed by measuring the total received wideband power (RTWP). Typically this measurement is performed by summing up squared receiver signal samples over a measurement time period which is typically either 10 ms or 2 ms.

Step 606. The radio base station estimates the noise floor using the measured second interference.

Thus, a more accurate noise floor estimate is achieved and thereby a more appropriate scheduling may be performed leading to an improved performance of the radio communications network.

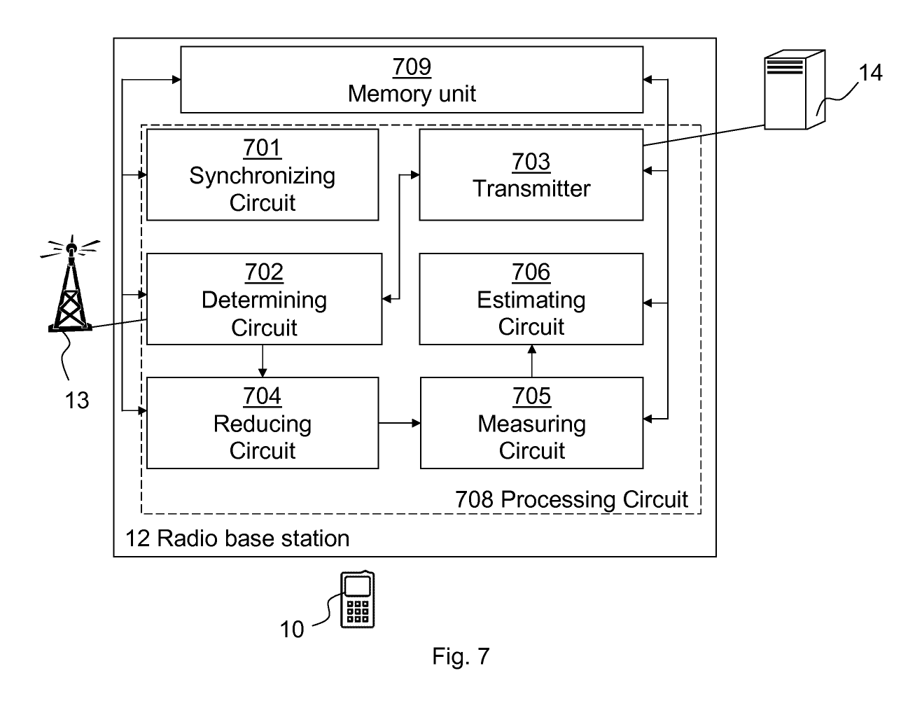

In order to perform the method a radio base station is provided. FIG. 7 is a block diagram depicting the radio base station 12 for estimating the noise floor in the cell 15 of a radio communications network. The radio base station 12,13 is configured to serve the cell 15.

The radio base station 12 may comprise a synchronization circuit 701 configured to synchronize an internal clock with a radio network clock.

Furthermore, the radio base station 12,13 comprises a determining circuit 702 configured to determine a time interval. The noise floor in the cell 15 is to be estimated in the time interval. The determining circuit 702 may further be configured to receive the time interval from a radio network node 13,14.

The radio base station 12 may in some embodiments further comprise a transmitter 703 configured to signal information to a radio network controller 14, which information comprises the time interval for reducing the first interference.

The radio base station 12 further comprises a reducing circuit 704 configured to reduce a first interference in the uplink during the determined time interval in the cell 15. The reducing circuit 704 is configured to reduce traffic or transmission power in the cell 15.

Also, the radio base station 12 comprises a measuring circuit 705 configured to measure a second interference at a time in the time interval in the cell 15 when the first interference is reduced. The radio base station 12 further comprises an estimating circuit 706 configured to estimate the noise floor using the measured second interference. The noise floor estimation may then be used in e.g. a scheduler in the radio base station 12.

The measuring of the second interference may be performed by measuring the total received wideband power (RTWP). Typically this measurement is performed by summing up squared receiver signal samples over a measurement time period which is typically either 10 ms or 2 ms.

The embodiments herein for estimating a noise floor in the cell 15 of the radio communications network may be implemented through one or more processors, such as a processing circuit 708 in the base station 12 depicted in FIG. 7, together with computer program code for performing the functions and/or method steps of the embodiments herein. The program code mentioned above may also be provided as a computer program product, for instance in the form of a data carrier carrying computer program code for performing the present solution when being loaded into the radio base station 12. One such carrier may be in the form of a CD ROM disc. It is however feasible with other data carriers such as a memory stick. The computer program code may furthermore be provided as pure program code on a server and downloaded to the radio base station 12.

The radio base station 12 may further comprise a respective memory 709 comprising one or more memory units. The memories are arranged to be used to store data such as thresholds, time intervals, SIR measurements, neighbour cell list and applications to perform the methods herein when being executed in the radio base station 12.

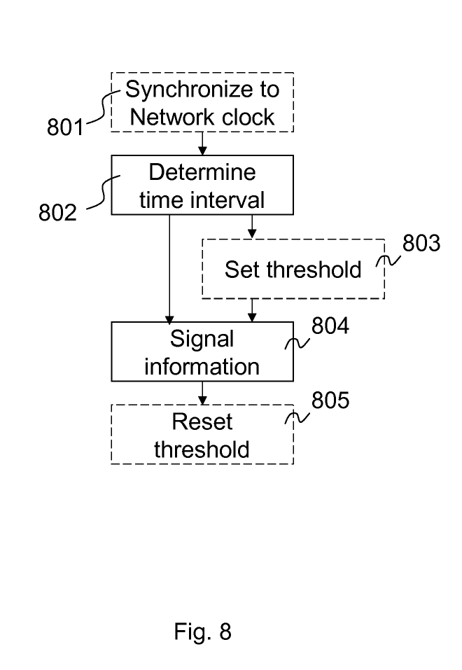

The method steps in the radio network controller, referred to as the radio network controller 12 in the figures, for enabling estimation of a noise floor in the cell 15 in the radio communications network according to some general embodiments will now be described with reference to a flowchart depicted in FIG. 8. The steps do not have to be taken in the order stated below, but may be taken in any suitable order. The radio network controller 14 is comprised in the radio communications network and controls a radio base station 12 serving the cell 15.

Step 801. The radio network controller 14 may in some embodiments synchronize an internal clock to a radio network clock. Thus, a time interval in the radio network controller 14 is similar within all synchronized radio network nodes in the radio communications network.

Step 802. The radio network controller 14 determines a time interval in which time interval the noise floor in the cell 15 is to be estimated. The radio network controller 14 may further determine which cells to signal the time interval to. For example, the radio network controller 14 may determine from a neighbour cell list which cells to transmit information relating to the time interval. The radio network controller 14 may determine the time interval by receiving information from the radio base station 12 or a radio network node 17, which information comprises the time interval. The radio network node may be a different radio base station, a different radio network controller or a core network node.

Step 803. In some embodiments the radio network controller 14 may set a threshold for admission of user equipments to the cell 15 to a second level, being lower than a first level so that less user equipments are admitted to the cell over the time interval than currently admitted.

Step 804. The radio network controller 14 signals information to the radio base station 12, a different radio base station 13, and/or a different radio network controller. The information is based on the time interval. For example, the information may comprise an indication when to estimate the noise floor, e.g. ‘start now’, in the cell 15 and this may be signaled to the radio base station 12 and/or the different radio base station 13. The information may in some embodiments indicate the time interval during which the noise floor in the cell 15 is to be estimated and may be transmitted to the radio base station 12. In some embodiments the information indicating the time interval is transmitted to the second radio base station 13 or other radio network controller controlling neighboring cells.

In some embodiments wherein the time interval is received from the radio base station 12 or a radio network node, the radio network controller 14 signals the time interval to a circuitry controlling at least one second cell 16 of the radio communications network.

In some embodiments, the radio network controller signals further information to a user equipment 10 within the cell 15, which information comprises an indication indicating a mode switch of the user equipment 10. It should here be under stood that the radio network node may alternatively or additionally signal a mode switch to one or more user equipment 11 in a neighbour cell 16. The mode switch may be to a mode using lower transmission rates, and/or lower transmission power.

Step 805. The radio network controller 14 may in some embodiments reset the threshold for admission of user equipments to the cell 15 to the first level after the time interval has expired. It should here be noted that the radio network controller 14 may set and reset thresholds for admissions to other cells as well in order to reduce neighbouring interference.

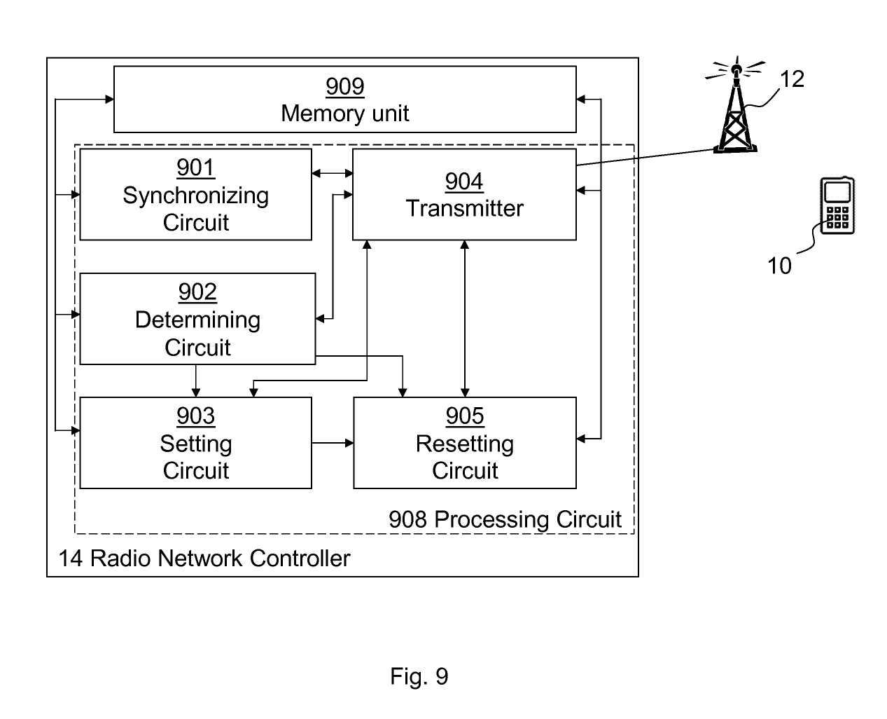

In order to perform the method a radio network controller is provided. FIG. 9 is a block diagram depicting the radio network controller 14 for enabling estimation of a noise floor in the cell 15 in the radio communications network. The radio network controller 14 is configured to control a radio base station serving the cell 15.

The radio network controller 14 may in some embodiments comprise a synchronization circuit 901 configured to synchronize an internal clock to a radio network clock of the radio communications network. The radio network controller 14 comprises a determining circuit 902 configured to determine a time interval in which time interval the noise floor in the cell 15 is to be estimated. The determining circuit 902 may in some embodiments be further configured to receive information from the radio base station 12 or a radio network node 17. The information may in these cases comprise the time interval. In some embodiments the determining circuit may be configured to determine which cells to signal the time interval to.

In some embodiments, the radio network controller 14 may comprise a setting circuit 903 configured to set a threshold for admission of user equipments to the cell 15 to a second level The second level is set to be lower than a first level so that less user equipments are admitted to the cell over the time interval than currently admitted. For example, the level may be set to ‘0’.

The radio network controller 14 further comprises a transmitter 904 configured to signal information to a radio network node, i.e. the radio base station 12, a different radio base station 13, and/or a different radio network controller 14. The information is based on the time interval. For example, the information may comprise an indication when to estimate the noise floor, e.g. ‘start now’, in the cell 15 and this may be signaled to the radio base station 12 and/or the different radio base station 13. The information may in some embodiments indicate the time interval during which the noise floor in the cell 15 is to be estimated and may be transmitted to the radio base station 12. In some embodiments the information indicating the time interval is transmitted the second radio base station 13 or other radio network controller controlling neighboring cells.

In case the determining circuit 902 has received information from the radio base station 12 or the radio network node 17, the transmitter 904 may be configured to signal the time interval to a circuitry. The circuitry is arranged to control at least one second cell 16 of the radio communications network.

In some embodiments the transmitter 904 may be configured to signal further information to a user equipment 10 within the cell 15, and/or user equipments in other cells. The information comprises an indication indicating a mode switch of the user equipment 10. The mode switch may be to a mode using lower transmission rates, and/or lower transmission power.

In some embodiments, the radio network controller 14 may comprise a resetting circuit 905 configured to reset the threshold to the first level after the time interval has expired.

The embodiments herein for enabling noise flow estimation may be implemented through one or more processors, such as a processing circuit 908 in the radio network controller 14 depicted in FIG. 9, together with computer program code for performing the functions and/or method steps of the embodiments herein. The program code mentioned above may also be provided as a computer program product, for instance in the form of a data carrier carrying computer program code for performing the present solution when being loaded into the radio network controller 14. One such carrier may be in the form of a CD ROM disc. It is however feasible with other data carriers such as a memory stick. The computer program code may furthermore be provided as pure program code on a server and downloaded to the radio network controller 14.

The radio network controller 14 may further comprise a respective memory 909 comprising one or more memory units. The memories are arranged to be used to store data such as thresholds, time intervals, SIR measurements, neighbour cell list and applications to perform the methods herein when being executed in the radio network controller 14.

In the drawings and specification, there have been disclosed exemplary embodiments herein. However, many variations and modifications can be made to these embodiments without substantially departing from the principles of the embodiments. Accordingly, although specific terms are employed, they are used in a generic and descriptive sense only and not for purposes of limitation, the scope of the invention being defined by the following claims.

1. A method in a radio base station for estimating a noise floor in a cell of a radio communications network, which radio base station is comprised in the radio communications network and serves the cell in the radio communications network, the method comprising:
determining a time interval in which time interval the noise floor in the cell is to be estimated,
reducing a first interference during the determined time interval in the cell,
measuring a second interference in the cell at a time in the time interval while the first interference remains reduced, and
estimating the noise floor using the measured second interference.

2. A method according to claim 1, further comprising signaling information to a radio network controller, which information comprises an indication of the time interval for reducing the first interference.

3. A method according to claim 1, wherein the reducing the first interference comprises reducing traffic or transmission power in the cell.

4. A method according to claim 1, further comprising synchronizing an internal clock, used to monitor the time interval, to a radio network clock.

5. A method according to claim 1, wherein the determining comprises receiving an indication of the time interval from a radio network node.

6. A method in a radio network controller for enabling estimation of a noise floor in a cell in a radio communications network, which radio network controller is comprised in the radio communications network and controls a radio base station serving the cell, the method comprising:
determining a time interval in which time interval the noise floor in the cell is to be estimated, and
signaling information to the radio base station, a different radio base station, and/or a different radio network controller, which information is based on the time interval.

7. A method according to claim 6, further comprising
setting a threshold for admission of user equipments to the cell to a second level, being lower than a first level, so that less user equipments are admitted to the cell over the time interval than currently admitted, and
resetting the threshold to the first level after the time interval has expired.

8. A method according to claim 6, further comprising synchronizing an internal clock, used to monitor the time interval, to a radio network clock.

9. A method according to claim 6, wherein determining comprises receiving information from the radio base station or a radio network node, which information comprises an indication of the time interval, and wherein the signaling comprises signaling the time interval to a circuitry controlling at least one second cell of the radio communications network.

10. A method according to claim 9, wherein the determining further comprises determining which cells to signal the time interval to.

11. A method according to claim 6, wherein the information signalled to the radio base station comprises an indication when to estimate the noise floor in the cell.

12. A method according to claim 6, wherein further information is signalled to a user equipment within the cell, which information comprises an indication indicating a mode switch of the user equipment, wherein the mode switch is to a mode using lower transmission rates, and/or lower transmission power.

13. A radio base station for estimating a noise floor in a cell of a radio communications network, which radio base station is configured to serve the cell, the radio base station comprises:
a determining circuit configured to determine a time interval in which time interval the noise floor in the cell is to be estimated,
a reducing circuit configured to reduce a first interference during the determined time interval in the cell,
a measuring circuit configured to measure a second interference in the cell at a time in the time interval while the first interference remains reduced, and
an estimating circuit configured to estimate the noise floor using the measured second interference.

14. A radio base station according to claim 13, further comprising a transmitter configured to signal information to a radio network controller, which information comprises an indication of the time interval for reducing the first interference.

15. A radio base station according to claim 13, wherein the reducing circuit is configured to reduce traffic or transmission power in the cell.

16. A radio base station according to claim 13, that further comprises a synchronizing circuit configured to synchronize an internal clock, used to monitor the time interval, to a radio network clock.

17. A radio base station according to claim 13, wherein the determining circuit is further configured to receive an indication of the time interval from a radio network node.

18. A radio network controller for enabling estimation of a noise floor in a cell in a radio communications network, which radio network controller is configured to control a radio base station serving the cell, the radio network controller comprises:
a determining circuit configured to determine a time interval in which time interval the noise floor in the cell is to be estimated, and
a transmitter configured to signal information to the radio base station, a different radio base station, and/or a different radio network controller, which information is based on the time interval.

19. A radio network controller according to claim 18, further comprising
a setting circuit configured to set a threshold for admission of user equipments to the cell to a second level, being lower than a first level so that less user equipments are admitted to the cell over the time interval than currently admitted, and
a resetting circuit configured to reset the threshold to the first level after the time interval has expired.

20. A radio network controller according to claim 18, further comprising a synchronizing circuit configured to synchronize an internal clock, used to monitor the time interval, to a radio network clock.

21. A radio network controller according to claim 18, wherein the determining circuit is further configured to receive information from the radio base station or a radio network node, which information comprises an indication of the time interval, and the transmitter is configured to signal the time interval to a circuitry controlling at least one second cell of the radio communications network.

22. A radio network controller according to claim 21, wherein the determining circuit is further configured to determine which cells to signal the time interval to.

23. A radio network controller according to claim 18, wherein the information to be signalled to the radio base station comprises an indication when to estimate the noise floor in the cell.

24. A radio network controller according to claim 18, wherein the transmitter is configured to signal further information to a user equipment within the cell, which information comprises an indication indicating a mode switch of the user equipment, wherein the mode switch is to a mode using lower transmission rates, and/or lower transmission power.
